(19) United States
(12) Patent Application Publication
(10) Pub. No.: US 2026/0031296 A1
(43) Pub. Date: Jan. 29, 2026

(54) SOLID-STATE HYBRID SWITCHGEAR AND CONTROL METHOD THEREFOR

(71) Applicant: Siemens Aktiengesellschaft, München (DE)

(72) Inventors: Jie Liu, Shanghai (CN); Mou Wang, Suzhou (CN); Karsten Handt, Berg (DE)

(21) Appl. No.: 19/283,539

(22) Filed: Jul. 29, 2025

(30) Foreign Application Priority Data
Jul. 29, 2024 (CN) 202411030317.X

(51) Int. Cl. H01H 33/664; H01H 9/54; H01H 33/59

(52) U.S. Cl. CPC H01H 33/664; H01H 9/542; H01H 33/596; H01H 2009/544

(57) ABSTRACT

A solid-state hybrid switchgear includes first and second isolating contacts, first and second arcing contacts, first and second switch units, and a control unit. The first switch unit is connected in parallel with the first arcing contact. The second switch unit is symmetrical with the first switch unit and connected in parallel with the second arcing contact. The control unit is separately connected to the first and second switch units, and configured to output a first control signal to turn on the first and/or second switch unit to transfer a contact current, and after receiving a current transfer signal, output a second control signal to control the first and/or second switch unit to be turned off. The high-voltage and high-current solid-state hybrid switchgear can extinguish arcs during the connection and disconnection process, thereby improving safety performance. A control method for the solid-state hybrid switchgear is also provided.

### CROSS-REFERENCE TO RELATED APPLICATION

This application claims the priority, under 35 U.S.C. § 119, of Chinese Patent Application CN 202411030317.X, filed Jul. 29, 2024; the prior application is herewith incorporated by reference in its entirety.

### FIELD AND BACKGROUND OF THE INVENTION

The present invention relates to the technical field of electrical devices, and in particular to a solid-state hybrid switchgear and a control method therefor.

### DESCRIPTION OF THE RELATED ART

With the development and advancement of new energy, the research on high-voltage and high-current solid-state hybrid switches has become a hot topic in the new era of power distribution systems. However, in the process of connecting and disconnecting current flow in high-voltage and high-current solid-state hybrid switchgears used in DC power distribution systems, arcs often occur between moving and stationary contacts.

Therefore, how to achieve safe connection and disconnection of solid-state hybrid switchgears has become a technical problem that needs to be solved urgently by those skilled in the art.

### SUMMARY OF THE INVENTION

It is accordingly an object of the invention to provide a solid-state hybrid switchgear and a control method therefor, which overcome the hereinafore-mentioned disadvantages of the heretofore-known devices and methods of this general type and which enable a high-voltage and high-current solid-state hybrid switchgear to extinguish arcs during the connection and disconnection process, thereby improving the safety performance of the device.

With the foregoing and other objects in view there is provided, in accordance with one aspect of the invention, a solid-state hybrid switchgear. The solid-state hybrid switchgear comprises a first isolating contact, a first arcing contact, a second isolating contact, a second arcing contact, a first switch unit, a second switch unit and a control unit. The first isolating contact cooperates with the first arcing contact, and the second isolating contact cooperates with the second arcing contact, the first switch unit is connected in parallel with the first arcing contact, the second switch unit is symmetrical with the first switch unit and connected in parallel with the second arcing contact, the control unit is separately connected to the first switch unit and the second switch unit, and configured to output a first control signal to the first switch unit and/or the second switch unit during a connection or disconnection process, so as to turn on the first switch unit and/or the second switch unit to transfer a contact current, and after receiving a current transfer signal, output a second control signal to the first switch unit and/or the second switch unit, so as to control the first switch unit and/or the second switch unit to be turned off, wherein the current transfer signal refers to transfer of a current from the first switch unit to the first arcing contact during the connection process and/or transfer of a current from the second switch unit to the second arcing contact during the connection process, or transfer of a current from the first arcing contact to the first switch unit during the disconnection process and/or transfer of a current from the second arcing contact to the second switch unit during the disconnection process.

In another illustrative implementation of the present invention, the solid-state hybrid switchgear further comprises a first detection unit and/or a second detection unit. The first detection unit is separately connected to the first isolating contact and the control unit, and configured to detect closing of the first isolating contact during the connection process, form a first detection signal, and output the first detection signal to the control unit, so that the control unit is informed that the first isolating contact is closed, and the second detection unit is symmetrical with the first detection unit, separately connected to the second isolating contact and the control unit, and configured to detect closing of the second isolating contact during the connection process, form a second detection signal, and output the second detection signal to the control unit, so that the control unit is informed that the second isolating contact is closed. The detection unit can ensure that the control unit is capable of accurately obtaining the status of the first isolating contact and/or the second isolating contact.

In still another illustrative implementation of the present invention, the solid-state hybrid switchgear further comprises a first sensing unit and/or a second sensing unit. The first sensing unit is provided between the first switch unit and the first arcing contact, connected to the control unit, and configured to sense the transfer of the current between the first switch unit and the first arcing contact, and to form a current transfer signal, and the second sensing unit is symmetrical with the first sensing unit, provided between the second switch unit and the second arcing contact, connected to the control unit, and configured to sense the transfer of the current between the second switch unit and the second arcing contact, and to form a current transfer signal. The sensing unit can ensure that the control unit is capable of accurately obtaining the current transfer information during the connection process and the disconnection process.

In yet another illustrative implementation of the present invention, when the control unit receives the first detection signal fed back by the first detection unit and the second detection signal fed back by the second detection unit, the control unit synchronously outputs the first control signal to the first switch unit and the second switch unit, so that the first switch unit and the second switch unit are synchronously turned on, and during the connection or disconnection process, when the control unit receives the current transfer signal sent by the first sensing unit and the current transfer signal sent by the second sensing unit, the control unit synchronously outputs the second control signal to the first switch unit and the second switch unit, so that the first switch unit and the second switch unit are synchronously turned off. The synchronous output of the control signal by the control unit can also synchronously control the drive enable of two groups of semiconductor switches in software control logic, so that the software and hardware control logic of the two groups of semiconductor switches is completely consistent.

In yet another illustrative implementation of the present invention, during the connection process, when the control unit receives the current transfer signal sent by the first sensing unit and/or the current transfer signal sent by the second sensing unit, the control unit is further configured to start timing, and when a first preset timing time period ends, output the second control signal to control the first switch unit and/or the second switch unit to be turned off, within the first preset timing time period, the current is completely transferred from the first switch unit to the first arcing contact and/or from the second switch unit to the second arcing contact, or during the disconnection process, when the control unit receives the current transfer signal sent by the first sensing unit and/or the current transfer signal sent by the second sensing unit, the control unit is further configured to start timing, and when a second preset timing time period ends, output the second control signal to control the first switch unit and/or the second switch unit to be turned off, within the second preset timing time period, the current is completely transferred from the first arcing contact to the first switch unit and/or from the second arcing contact to the second switch unit, and the first preset timing time period is greater than the second preset timing time period. The control unit can also ensure that the main circuit current is completely transferred from the switch unit to the arcing contact and/or from the arcing contact to the switch unit during the connection process.

In yet another illustrative implementation of the present invention, the first switch unit and the second switch unit are bidirectional semiconductor switch units or unidirectional semiconductor switch units. The bidirectional semiconductor switch unit can make the fixed hybrid switchgear flexible and compatible. The bidirectional semiconductor switch unit can make the fixed hybrid switchgear flexible and compatible. The unidirectional semiconductor switch unit can reduce the cost of the fixed hybrid switchgear.

In yet another illustrative implementation of the present invention, the solid-state hybrid switchgear further comprises a DC positive terminal and a DC negative terminal, when the first isolating contact, the first arcing contact, the second isolating contact and the second arcing contact are provided between the DC positive terminal and the DC negative terminal, and the first switch unit and the second switch unit are both bidirectional semiconductor switch units, the solid-state hybrid switchgear is a bidirectional bipolar solid-state hybrid switchgear, when only the first isolating contact and the first arcing contact are provided between the DC positive terminal and the DC negative terminal, and the first switch unit is a bidirectional semiconductor switch unit, or only the second isolating contact and the second arcing contact are provided between the DC positive terminal and the DC negative terminal, and the second switch unit is a bidirectional semiconductor switch unit, the solid-state hybrid switchgear is a bidirectional unipolar solid-state hybrid switchgear, when the first isolating contact, the first arcing contact, the second isolating contact, and the second arcing contact are provided between the DC positive terminal and the DC negative terminal, and the first switch unit and the second switch unit are both unidirectional semiconductor switch units, the solid-state hybrid switchgear is a unidirectional bipolar solid-state hybrid switchgear, and when only the first isolating contact and the first arcing contact are provided between the DC positive terminal and the DC negative terminal, and the first switch unit is a unidirectional semiconductor switch unit, or only the second isolating contact and the second arcing contact are provided between the DC positive terminal and the DC negative terminal, and the second switch unit is a unidirectional semiconductor switch unit, the solid-state hybrid switchgear is a unidirectional unipolar solid-state hybrid switchgear. The solid-state hybrid switchgear is flexible in configuration and is suitable for unipolar, bipolar, unidirectional, bidirectional, and various installation and wiring manners of different voltage levels.

In yet another illustrative implementation of the present invention, the solid-state hybrid switchgear further comprises a first isolation unit and/or a second isolation unit. The first isolation unit is connected to the first detection unit, and configured to convert a high voltage input of the solid-state hybrid switchgear into a low voltage output, and the second isolation unit is symmetrical with the first isolation unit, connected to the second detection unit, and configured to convert a high voltage input of the solid-state hybrid switchgear into a low voltage output. The isolation units can ensure a sufficiently safe electrical spacing, which is more advantageous for communication.

In yet another illustrative implementation of the present invention, the solid-state hybrid switchgear further comprises a first protection unit and/or a second protection unit. The first protection unit is connected in parallel with the first switch unit, and configured to limit an input voltage of the first switch unit, and the second protection unit is symmetrical with the first protection unit, connected in parallel with the second switch unit, and configured to limit an input voltage of the second switch unit. The protection units can prevent a surge voltage from breaking down the first switch unit and the second switch unit.

Meanwhile, the present invention further discloses a control method for a solid-state hybrid switchgear, which enables a high-voltage and high-current solid-state hybrid switchgear to extinguish arcs during the connection and disconnection process, thereby improving the safety performance of the device.

With the objects of the invention in view, there is also provided, in accordance with another aspect, a control method for a solid-state hybrid switchgear. The control method is applied to the solid-state hybrid switchgear described previously, wherein the solid-state hybrid switchgear includes a first isolating contact, a first arcing contact, a second isolating contact, a second arcing contact, a first switch unit, a second switch unit and a control unit, the first isolating contact cooperates with the first arcing contact, the second isolating contact cooperates with the second arcing contact, the first switch unit is connected in parallel with the first arcing contact, the second switch unit is connected in parallel with the second arcing contact, and the control unit is separately connected to the first switch unit and the second switch unit, the control method comprises during a connection or disconnection process, outputting a first control signal to the first switch unit and/or the second switch unit to control the first switch unit and/or the second switch unit to be turned on, so as to transfer a contact current, and when a current transfer signal is received, outputting a second control signal to the first switch unit and/or the second switch unit to control the first switch unit and/or the second switch unit to be turned off, wherein the current transfer signal includes transfer of a current from the first switch unit to the first arcing contact during the connection process and/or transfer of a current from the second switch unit to the second arcing contact during the connection process, or transfer of a current from the first arcing contact to the first switch unit during the disconnection process and/or transfer of a current from the second arcing contact to the second switch unit during the disconnection process.

In yet another illustrative implementation of the present invention, the control method further comprises during the connection process, when the current transfer signal is received, starting timing, and when a first preset timing time period ends, outputting the second control signal, within the first preset timing time period, completely transferring the current from the first switch unit to the first arcing contact and/or from the second switch unit to the second arcing contact, or during the disconnection process, when the current transfer signal is received, starting timing, and when a second preset timing time period ends, outputting the second control signal, within the second preset timing time period, completely transferring the current from the first arcing contact to the first switch unit and/or from the second arcing contact to the second switch unit.

Other features which are considered as characteristic for the invention are set forth in the appended claims.

Although the invention is illustrated and described herein as embodied in a solid-state hybrid switchgear and a control method therefor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, which merely illustratively describe and explain the present invention and do not limit the scope of the present invention.

### BRIEF DESCRIPTION OF THE FIGURES

FIG. 1 is a block diagram showing an exemplary principle of a solid-state hybrid switchgear of the present invention;

FIG. 2 is an exemplary diagram of a bidirectional bipolar solid-state hybrid switchgear of the present invention;

FIG. 3 is an exemplary diagram of a unidirectional bipolar solid-state hybrid switchgear of the present invention;

FIG. 4 is a timing diagram of connection and disconnection processes of a solid-state hybrid switchgear of the present invention; and

FIG. 5 is an exemplary flowchart of a control method for turning on a solid-state hybrid switchgear of the present invention.

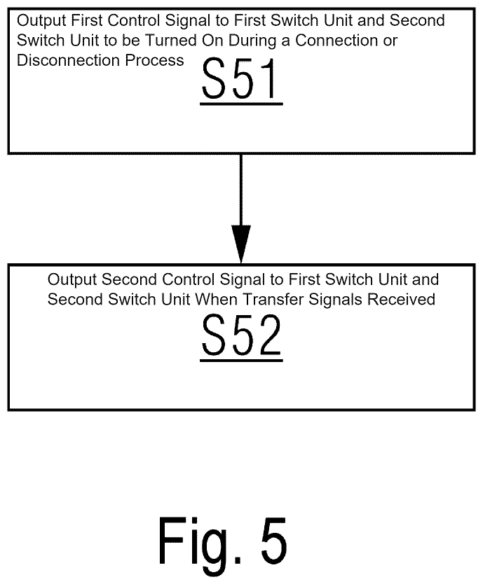

### DETAILED DESCRIPTION OF THE INVENTION

In order to provide a clearer understanding of the technical features, objectives and effects of the present invention, specific embodiments of the present invention will be described below with reference to the drawings, wherein identical reference signs in each figure indicate components that have the same structure or components that have similar structures but the same function.

As used herein, “schematic” means “serving as an instance, example or illustration.” No drawing or embodiment described herein as “schematic” should be interpreted as being a more preferred or more advantageous technical solution.

To make the drawings appear uncluttered, only those parts relevant to the present invention are shown schematically in the drawings; they do not represent the actual structure thereof as a product. Furthermore, to make the drawings appear uncluttered for ease of understanding, in the case of components having the same structure or function in certain drawings, only one of these is drawn schematically, or only one is marked.

In this text, “a” does not only mean “just this one;” it may also mean “more than one.” In this text, “first,” “second,” etc. are merely used to differentiate between parts, not to indicate the order or degree of importance between parts, etc.

In the process of disconnecting a current in a high-voltage and high-current solid-state hybrid switchgear used in a DC power distribution system in the prior art, an arc is often generated between moving and stationary contacts, and it is difficult to extinguish that arc naturally, making it impossible for the solid-state hybrid switchgear to be safely connected and disconnected.

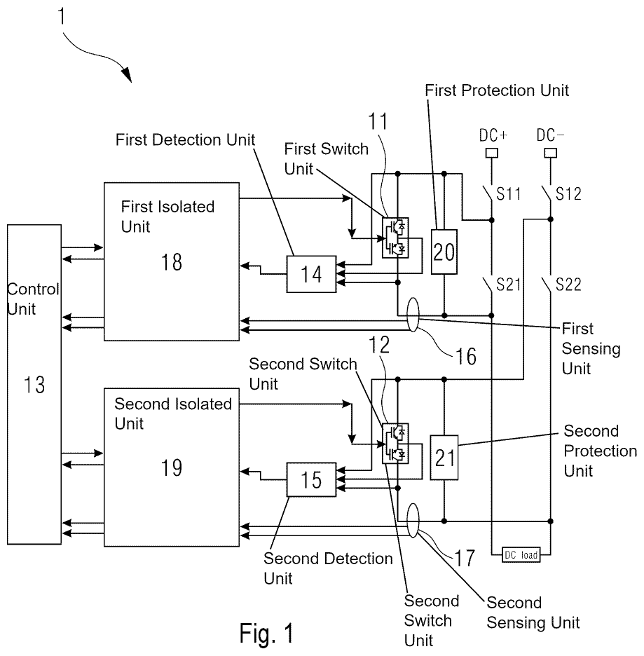

Referring now to the figures of the drawings in detail and first, particularly, to FIG. 1 thereof, it is therefore seen that the present application provides a solid-state hybrid switchgear 1 as shown in FIG. 1. The solid-state hybrid switchgear 1 includes a first isolating contact S11, a first arcing contact S21 cooperating with the first isolating contact S11 (the first isolating contact S11 and the first arcing contact S21 form a main circuit of one pole), a second isolating contact S12, a second arcing contact S22 cooperating with the second isolating contact S12 (the second isolating contact S12 and the second arcing contact S22 form a main circuit of the other pole), a first switch unit 11, a second switch unit 12 and a control unit 13.

The first switch unit 11 is connected in parallel with the first arcing contact S21. The first switch unit 11 is configured to transfer a contact current. The second switch unit 12 is symmetrical with the first switch unit 11 and is connected in parallel with the second arcing contact S22. The second switch 12 is configured to transfer a contact current. In this embodiment, the symmetrical configuration of the first switch unit 11 and the second switch unit 12 can ensure that when the solid-state hybrid switchgear is a bipolar solid-state hybrid switchgear, ON and OFF of the two groups of switch units are synchronized in hardware.

During the connection process, the control unit 13 uses the connection time difference between the isolating contact and the arcing contact. After the isolating contact is closed, the control unit outputs a first control signal to the first switch unit 11 and/or the second switch unit 12 to turn on the first switch unit 11 and/or the second switch unit 12. After the arcing contact is closed, the first switch unit 11 and/or the second switch unit 12 transfers the contact current, and after receiving a current transfer signal, the control unit outputs a second control signal to the first switch unit 11 and/or the second switch unit 12 to control the first switch unit 11 and/or the second switch unit 12 to be turned off, thereby completing the connection of the solid-state hybrid switchgear 1.

During the disconnection process, the control unit 13 uses the disconnection time difference between the arcing contact and the isolating contact, and outputs the first control signal to the first switch unit 11 and/or the second switch unit 12 to turn on the first switch unit 11 and/or the second switch unit 12. After the arcing contact is closed, the first switch unit 11 and/or the second switch unit 12 assist in current transfer, and after receiving the current transfer signal, the control unit outputs a second control signal to the first switch unit 11 and/or the second switch unit 12 to control the first switch unit 11 and/or the second switch unit 12 to be turned off, and then disconnect the isolating contact to complete the disconnection of the solid-state hybrid switchgear 1.

In this embodiment, the current transfer signal refers to the transfer of a current from the first switch unit 11 to the first arcing contact S21 during the connection process and/or the transfer of a current from the second switch unit 12 to the second arcing contact S22 during the connection process, or the transfer of a current from the first arcing contact S21 to the first switch unit 11 during the disconnection process and/or the transfer of a current from the second arcing contact S22 to the second switch unit 12 during the disconnection process. The solid-state hybrid switchgear provided by the present application controls ON and OFF of the first switch unit 11 and/or the second switch unit 12 through the control unit during the connection and disconnection processes, so that a current flowing between the first switch unit 11 and the first arcing contact S21 and/or a current flowing between the second switch unit 12 and the second arcing contact 32 is transferred, thereby extinguishing arcs generated by the solid-state hybrid switchgear during the connection and disconnection processes, and realizing safe connection and disconnection.

In order to make the fixed hybrid switchgear flexible and compatible, the first switch unit 11 and the second switch unit 12 of this embodiment may be bidirectional semiconductor switch units. In practical applications, the bidirectional semiconductor switch unit is a bidirectional IGBT module. The bidirectional IGBT module may allow users to use different installation manners conveniently, and may not require distinguishing between the positive and negative poles of the power supply.

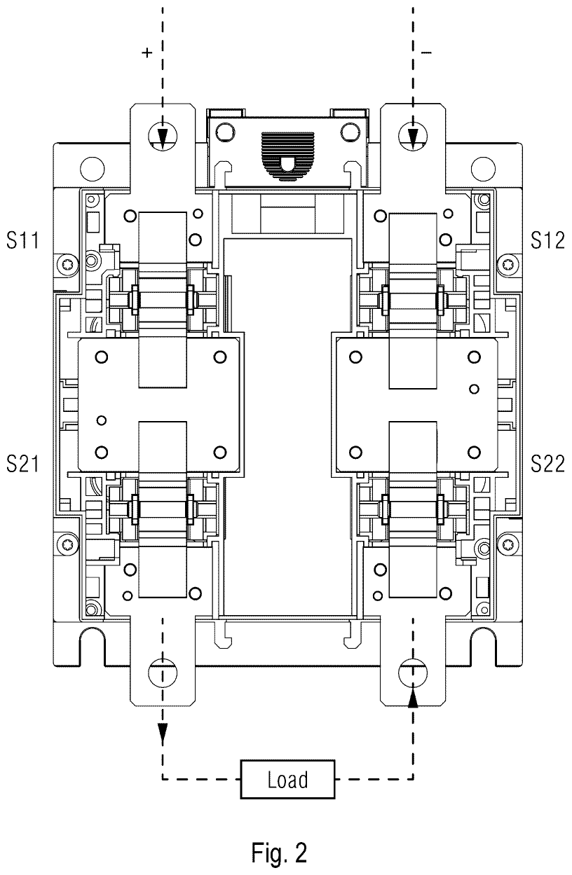

Specifically, when the first isolating contact S11, the first arcing contact S21, the second isolating contact S12 and the second arcing contact S22 are provided between the DC positive terminal DC+ and the DC negative terminal DC−, and the first switch unit 11 and the second switch unit 12 are both bidirectional semiconductor switch units, the solid-state hybrid switchgear is a bidirectional bipolar solid-state hybrid switchgear, such as the solid-state hybrid switchgear shown in FIG. 2.

Specifically, when only the first isolating contact S11 and the first arcing contact S21 are provided between the DC positive terminal DC+ and the DC negative terminal DC−, the first switch unit 11 is a bidirectional semiconductor switch unit, or only the second isolating contact S12 and the second arcing contact S22 are provided between the DC positive terminal DC+ and the DC negative terminal DC−, and the second switch unit 12 is a bidirectional semiconductor switch unit, the solid-state hybrid switchgear is a bidirectional unipolar solid-state hybrid switchgear.

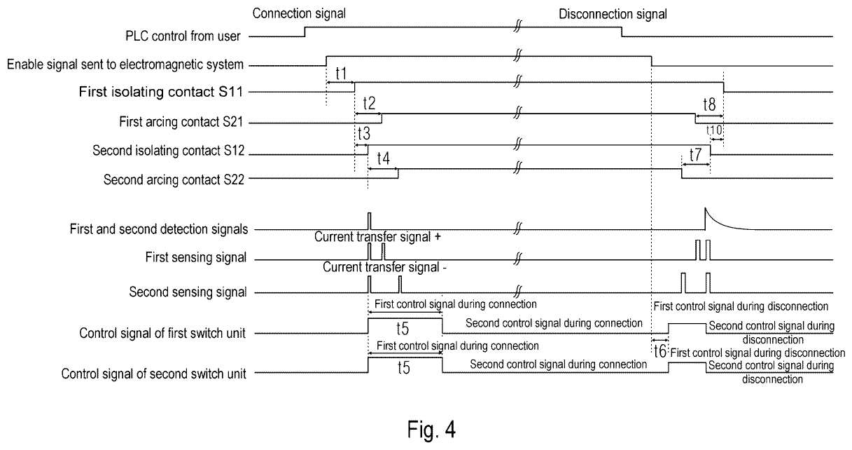

In order to limit the cost of the fixed hybrid switchgear, the first switch unit 11 and the second switch unit 12 of this embodiment may be unidirectional semiconductor switch units. In practical applications, the unidirectional semiconductor switch unit is a unidirectional IGBT module. In practical applications, the first control signal may be represented as a high level as shown in FIG. 4, and the second control signal may be represented as a low level as shown in FIG. 4.

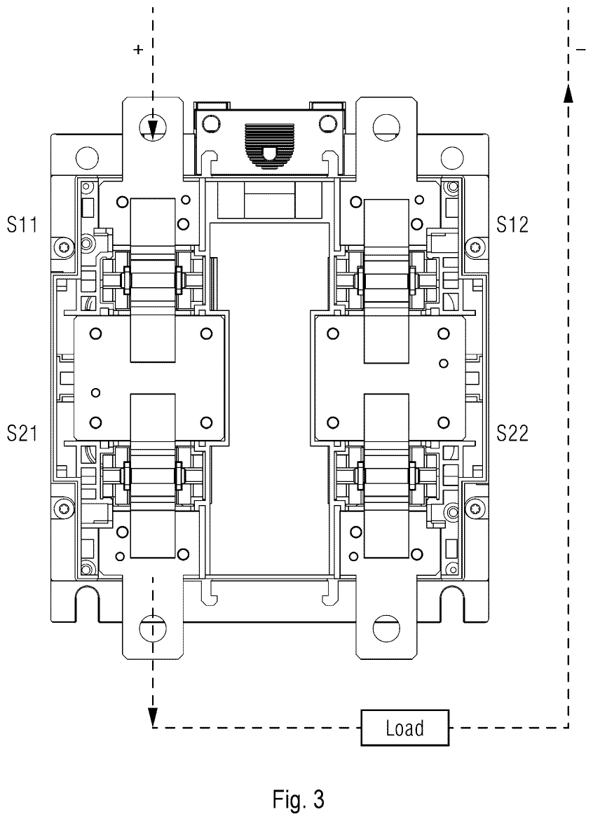

Specifically, when the first isolating contact S11, the first arcing contact S21, the second isolating contact S12, and the second arcing contact S22 are provided between the DC positive terminal DC+ and the DC negative terminal DC−, and the first switch unit 11 and the second switch unit 12 are both unidirectional semiconductor switch units, the solid-state hybrid switchgear is a unidirectional bipolar solid-state hybrid switchgear, such as the solid-state hybrid switchgear shown in FIG. 3. Alternatively, specifically, when only the first isolating contact S11 and the first arcing contact S21 are provided between the DC positive terminal DC+ and the DC negative terminal DC−, and the first switch unit 11 is a unidirectional semiconductor switch unit, or only the second isolating contact S12 and the second arcing contact S22 are provided between the DC positive terminal DC+ and the DC negative terminal DC−, and the second switch unit 12 is a unidirectional semiconductor switch unit, the solid-state hybrid switchgear is a unidirectional unipolar solid-state hybrid switchgear.

For ease of understanding, a bipolar solid-state hybrid switchgear will be taken as an example for detailed description below.

In order to ensure that the control unit can accurately obtain the status of the first isolating contact and/or the second isolating contact, the solid-state hybrid switchgear 1 of this embodiment further includes a first detection unit 14 and a second detection unit 15 as shown in FIG. 2.

In order to ensure that the control unit can accurately obtain the current transfer information during the connection and disconnection processes, the solid-state hybrid switchgear 1 of this embodiment further includes a first sensing unit 16 and a second sensing unit 17 as shown in FIG. 1.

The first detection unit 14 is separately connected to the first isolating contact S11 and the control unit 13. The first detection unit 14 is configured to detect the closing of the first isolating contact S11 during the connection process, to form a first detection signal, and to output the first detection signal to the control unit 13, so that the control unit 13 is informed that the first isolating contact S11 is closed.

The second detection unit 15 is symmetrically disposed with the first detection unit 14, and the second detection unit 15 is separately connected to the second isolating contact S12 and the control unit 13. The second detection unit 15 is configured to detect the closing of the second isolating contact S12 during the connection process, to form a second detection signal, and to output the second detection signal to the control unit 13, so that the control unit 13 is informed that the second isolating contact S12 is closed.

In practical applications, the first detection unit 14 and the second detection unit 15 may use an optical coupler, a comparator or an operational amplifier to detect the contact status.

The first sensing unit 16 is provided between the first switch unit 11 and the first arcing contact S21, and is connected to the control unit 13. The first sensing unit 16 is configured to sense the transfer of a current between the first switch unit 11 and the first arcing contact S21, and to form a current transfer signal. The current transfer signal is that during the connection process, when the first arcing contact S21 is closed, the current is transferred from the first switch unit 11 to the first arcing contact S21, or during the disconnection process, when the first arcing contact S21 is disconnected, the current is transferred from the first arcing contact S21 to the first switch unit 11.

The second sensing unit 17 symmetrical with the first sensing unit 16 is provided between the second switch unit 12 and the second arcing contact S22, and is connected to the control unit 13. The second sensing unit 17 is configured to sense the transfer of a current between the second switch unit 12 and the second arcing contact S22, and to form a current transfer signal. The current transfer signal is that during the connection process, when the second arcing contact S22 is closed, the current is transferred from the second switch unit 12 to the second arcing contact S22, or during the disconnection process, when the second arcing contact S22 is disconnected, the current is transferred from the second arcing contact S22 to the second switch unit 12.

In order to ensure that the main circuit current is completely transferred from the switch unit to the arcing contact during the connection process, in this embodiment, during the connection process, after the control unit 13 receives the current transfer signal sent by the first sensing unit 16 and the current transfer signal sent by the second sensing unit 17, the control unit 13 is further configured to start timing, and to output the second control signal when a first preset timing time period ends. Within the first preset timing time period, the current is completely transferred from the first switch unit 11 to the first arcing contact S21, and the current is completely transferred from the second switch unit 12 to the second arcing contact S22.

In order to ensure that the main circuit current is completely transferred from the arcing contact to the switch unit during the connection process, in this embodiment, during the disconnection process, after the control unit 13 receives the current transfer signal sent by the first sensing unit 16 and the current transfer signal sent by the second sensing unit 17, the control unit 13 is further configured to start timing, and when a second preset timing time period ends, to output the second control signal to control the first switch unit 11 and the second switch unit 12 to be turned off. Within the second preset timing time period, the current is completely transferred from the first arcing contact S21 to the first switch unit 11 and from the second arcing contact S22 to the second switch unit 12. The first preset timing time period is greater than the second preset timing time period.

As shown in FIG. 4, when the control unit 13 receives a connection signal from a user, the control unit 13 sends an enable signal to an electromagnetic system, and the first isolating contact S11 and the second isolating contact S12 are closed successively (with reference to the timing sequence shown in FIG. 4, t1 represents a time interval for the electromagnetic system and the first isolating contact S11 to be completely closed, and t3 represents a time interval for the first isolating contact S11 and the second isolating contact S12 to be completely closed). When the control unit 13 receives the first detection signal fed back by the first detection unit 14 and the second detection signal fed back by the second detection unit 15, as shown in the timing diagram, the control unit 13 synchronously outputs the first control signal to the first switch unit 11 and the second switch unit 12 (as shown in FIG. 4, the first control signal sent to the first switch unit 11 and the first control signal sent to the second switch unit 12 are synchronously output during connection, and t5 represents an ON time of the first switch unit 11 and the second switch unit 12), so as to control the first switch unit 11 and the second switch unit 12 to be synchronously turned on. The synchronous output of the control signal by the control unit can also synchronously control the drive enable of two groups of semiconductor switches in software control logic, so that the software and hardware control logic of the two groups of semiconductor switches is completely consistent.

With continued reference to FIG. 1, before the first arcing contact S21 and the second arcing contact S22 are closed, the current flows from the first isolating contact S11 through the first switch unit 11, through a load 2 to the second switch unit 12, and then to the second isolating contact S12. After the first arcing contact S21 and the second arcing contact S22 are closed successively (with reference to the timing sequence shown in FIG. 4, t2 represents a time interval between the first isolating contact S11 being fully closed and the first arcing contact S21 being fully closed, and t4 represents a time interval between the second isolating contact S12 being fully closed and the second arcing contact S22 being fully closed), since the internal resistance of the first arcing contact S21 is smaller than the internal resistance of the first switch unit 11, the current is transferred from the first switch unit 11 to the first arcing contact S21, and the first sensing unit 16 senses and forms a current transfer signal (the current transfer signal is shown as the current transfer signal + in FIG. 4), and transmits it to the control unit 13. Since the internal resistance of the second arcing contact S22 is smaller than the internal resistance of the second switch unit 12, the current is transferred from the second switch unit 12 to the second arcing contact S22, and the second sensing unit 17 senses and generates a current transfer signal (the current transfer signal is the current transfer signal − shown in FIG. 4), and transmits it to the control unit 13. When the control unit 13 receives the current transfer signal + sent by the first sensing unit 16 and the current transfer signal − sent by the second sensing unit 16, in order to ensure that the main circuit current is completely transferred from the first switch unit 11 to the first arcing contact S21, after the second switch unit 12 is completely transferred to the second arcing contact S22, a second control signal (the second control signal during connection as shown in FIG. 4) is synchronously output to the first switch unit 11 and the second switch unit 12 to control the first switch unit 11 and the second switch unit 12 to be turned off, so that the connection process is completed.

With continued reference to FIG. 4, when the control unit 13 receives a disconnection signal from the user, the control unit 13 sends an enable signal to the electromagnetic system, and then synchronously outputs a first control signal to the first switch unit 11 and the second switch unit 12 (as shown in the timing sequence of FIG. 4, t6 represents a delay time between the disconnection of a magnetic power supply and ON of the two switch units during the disconnection process, and the first control signal at this time is the first control signal during disconnection as shown in FIG. 4), so as to control the first switch unit 11 and the second switch unit 12 to be turned on synchronously. After the second arcing contact S22, the second arcing contact S22 and the first arcing contact S21 are disconnected successively (as shown in the timing sequence of FIG. 4, t7 represents a time interval between the second arcing contact S22 being fully opened and the second isolating contact S12 being fully opened, t8 represents a time interval between the first arcing contact S21 being fully opened and the first isolating contact S11 being fully opened, and t9 represents a time interval between the second isolating contact S12 being fully opened and the first isolating contact being fully opened), the main circuit is disconnected, a main circuit current is transferred from the first arcing contact S21 to the first switch unit 11, the first sensing unit 16 forms a current transfer signal (the current transfer signal is the current transfer signal + as shown in FIG. 4), and transmits it to the control unit 13, the main circuit current is transferred from the second arcing contact S22 to the second switch unit 12, and the second sensing unit 17 also generates a current transfer signal (the current transfer signal is the current transfer signal − as shown in FIG. 4), and transmits it to the control unit 13. When the control unit 13 receives the current transfer signal + sent by the first sensing unit 16 and the current transfer signal − sent by the second sensing unit 16, in order to ensure that the main circuit current is completely transferred from the first arcing contact S21 to the first switch unit 11 and from the second arcing contact S22 to the second switch unit 12, the control unit synchronously outputs a second control signal (the second control signal is the second control signal during disconnection as shown in FIG. 4) to the first switch unit 11 and the second switch unit 12, so as to control the first switch unit 11 and the second switch unit 12 to be turned off, so that the disconnection process is completed. In order to better drive the fixed hybrid switchgear, the rated voltage that the first switch unit 11 and the second switch unit 12 can withstand in this embodiment is greater than the input voltage of the solid-state hybrid switchgear. For example, a bipolar solid-state hybrid switchgear with a voltage of 1500 V requires at least a 2400 V semiconductor switch module to be implemented according to traditional configuration concepts and configuration parameters. However, in this embodiment, by detecting the bipolar solid-state hybrid switchgear through a signal, the first switch unit 11 and the second switch unit 12 are simultaneously turned on or off, which indirectly reduces the requirements of the bipolar solid-state hybrid switchgear on the electrical parameter indicators of the semiconductor switch, reduces the success while ensuring the function, and reduces the size of the device. For example, the first switch unit 11 and the second switch unit 12 may each use a semiconductor switch with a rated voltage of 1700 V.

In order to ensure a sufficiently safe electrical spacing and creepage spacing and to further facilitate communication, as shown in FIG. 1, the solid-state hybrid switchgear 1 further includes a first isolation unit 18 and a second isolation unit 19.

Specifically, the first isolation unit 18 is connected to the first detection unit 14 and is configured to convert a high voltage input of the solid-state hybrid switchgear into a low voltage output.

The second isolation unit 19 is symmetrically disposed with the first isolation unit (18), connected to the second detection unit 15, and configured to convert a high voltage input of the solid-state hybrid switchgear into a low voltage output.

In order to prevent a surge voltage from breaking down the first switch unit and the second switch unit, and prevent overshoot voltages of the first switch unit and the second switch unit, as shown in FIG. 1, the solid-state hybrid switchgear 1 further includes a first protection unit 20 and a second protection unit 21.

Specifically, the first protection unit 20 is connected in parallel with the first switch unit 11. The first protection unit 20 is configured to limit the input voltage of the first switch unit 11.

The second protection unit 21 is symmetrically disposed with the first protection unit 20 and connected in parallel with the second switch unit 12. The second protection unit 21 is configured to limit the input voltage of the second switch unit 12.

In practical applications, both the first protection unit 20 and the second protection unit 21 may adopt high-energy varistors, RCDs, RCs or the like.

The present application further provides a control method for a solid-state hybrid switchgear. The control method is applied to the solid-state hybrid switchgear 1 described previously. A bipolar solid-state hybrid switchgear will be used as an example below. With reference to FIG. 6, the control method for the solid-state hybrid switchgear includes the following steps:

S51: During a connection or disconnection process, a first control signal is output to the first switch unit and the second switch unit to control the first switch unit 11 and the second switch unit 12 to be turned on, so as to transfer a contact current.

Specifically, during the connection process, S51 includes synchronously outputting the first control signal to the first switch unit and the second switch unit when the first detection signal fed back by the first detection unit and the second detection signal fed back by the second detection unit are received, so that the first switch unit and the second switch unit are synchronously turned on.

Specifically, during the disconnection process, S51 includes synchronously outputting the first control signal to the first switch unit and the second switch unit, so that the first switch unit and the second switch unit are synchronously turned on.

S52: When a current transfer signal is received, a second control signal is output to the first switch unit and the second switch unit to control the first switch unit and the second switch unit to be turned off. The current transfer signal includes the transfer of a current from the first switch unit to the first arcing contact during the connection process and/or the transfer of a current from the second switch unit to the second arcing contact during the connection process, or the transfer of a current from the first arcing contact to the first switch unit during the disconnection process and/or the transfer of a current from the second arcing contact to the second switch unit during the disconnection process.

Specifically, during the connection or disconnection process, S52 includes synchronously outputting the second control signal to the first switch unit and the second switch unit after the current transfer signal sent by the first sensing unit and the current transfer signal sent by the second sensing unit are received, so that first switch unit and the second switch unit are synchronously turned off.

In order to ensure that the main circuit current is completely transferred from the switch unit to the arcing contact during the connection process, in this embodiment, during the connection process, after the current transfer signal sent by the first sensing unit and the current transfer signal sent by the second sensing unit are received, S52 further includes starting timing, and outputting the second control signal when a first preset timing time period ends. Within the first preset timing time period, the current is completely transferred from the first switch unit to the first arcing contact, and the current is completely transferred from the second switch unit to the second arcing contact.

In order to ensure that the main circuit current is completely transferred from the arcing contact to the switch unit during the connection process, in this embodiment, during the disconnection process, after the current transfer signal sent by the first sensing unit and the current transfer signal sent by the second sensing unit are received, S52 further includes starting timing, and when a second preset timing time period ends, outputting the second control signal to control the first switch unit and the second switch unit to be turned off. Within the second preset timing time period, the current is completely transferred from the first arcing contact to the first switch unit and from the second arcing contact to the second switch unit. The first preset timing time period is greater than the second preset timing time period.

In summary, the technical solution provided by the present application can enable the high-voltage and high-current solid-state hybrid switchgear to extinguish arcs during the connection and disconnection process, thereby improving the safety performance of the device. Therefore, the present invention effectively overcomes various shortcomings in the prior art and has high industrial utilization value.

It should be understood that, although the specification is described according to various embodiments, not each of the embodiments contains only one independent technical solution. This description of the specification is merely for the sake of clarity. Those skilled in the art should consider the specification as a whole, and the technical solutions in the various embodiments can also be combined as appropriate to form other embodiments that can be understood by those skilled in the art.

The series of detailed descriptions set forth above are merely specific illustrations of feasible embodiments of the present invention, and are not intended to limit the scope of protection of the present invention. Equivalent implementations or variations without departing from the technical spirit of the present invention, such as combinations, divisions, or repetitions of the features, should fall within the scope of protection of the present invention. A noun or pronoun referring to a person in the present patent application is not limited to a specific gender.

The following is a summary list of reference numerals and the corresponding structure used in the above description of the invention:

| | |
|---|---|
| 1 | Solid-state hybrid switchgear |
| S11 | First isolating contact |
| S21 | First arcing contact |
| S12 | Second isolating contact |
| S22 | Second arcing contact |
| 11 | First switch unit |
| 12 | Second switch unit |
| 14 | First detection unit |
| 15 | Second detection unit |
| 16 | First sensing unit |
| 17 | Second sensing unit |
| 18 | First isolation unit |
| 19 | Second isolation unit |
| 20 | First protection unit |
| 21 | Second protection unit |
| DC+ | DC positive terminal |
| DC− | DC negative terminal |
| S51-S52 | Steps of control method |

1. A solid-state hybrid switchgear, comprising:
a first isolating contact, a first arcing contact, a second isolating contact and a second arcing contact, said first isolating contact cooperating with said first arcing contact, and said second isolating contact cooperating with said second arcing contact;
a first switch unit connected in parallel with said first arcing contact;
a second switch unit being symmetrical with said first switch unit and connected in parallel with said second arcing contact; and
a control unit separately control-connected to said first switch unit and to said second switch unit, said control unit configured to:
output a first control signal to at least one of said first switch unit or said second switch unit during a connection or disconnection process, to turn on at least one of said first switch unit or said second switch unit to transfer a contact current; and
after receiving a current transfer signal, output a second control signal to at least one of said first switch unit or said second switch unit, to control at least one of said first switch unit or said second switch unit to be turned off;
the current transfer signal referring to at least one of transfer of a current from said first switch unit to said first arcing contact during the connection process or transfer of a current from said second switch unit to said second arcing contact during the connection process, or at least one of transfer of a current from said first arcing contact to said first switch unit during the disconnection process or transfer of a current from said second arcing contact to said second switch unit during the disconnection process.

2. The solid-state hybrid switchgear according to claim 1, which further comprises at least one of:
a first detection unit separately connected to said first isolating contact and to said control unit, said first detection unit configured to detect closing of said first isolating contact during the connection process, form a first detection signal, and output the first detection signal to said control unit, informing said control unit that said first isolating contact is closed, or
a second detection unit being symmetrical with said first detection unit and separately connected to said second isolating contact and said control unit, said second detection unit configured to detect closing of said second isolating contact during the connection process, form a second detection signal, and output the second detection signal to said control unit, informing said control unit that said second isolating contact is closed.

3. The solid-state hybrid switchgear according to claim 2, which further comprises at least one of:
a first sensing unit provided between said first switch unit and said first arcing contact, connected to said control unit, and configured to sense the transfer of the current between said first switch unit and said first arcing contact and to form a current transfer signal, or
a second sensing unit being symmetrical with said first sensing unit, provided between said second switch unit and said second arcing contact, connected to said control unit, and configured to sense the transfer of the current between said second switch unit and said second arcing contact and to form a current transfer signal.

4. The solid-state hybrid switchgear according to claim 3, wherein:
upon said control unit receiving the first detection signal fed back by said first detection unit and the second detection signal fed back by said second detection unit, said control unit synchronously outputting the first control signal to said first switch unit and to said second switch unit, causing said first switch unit and said second switch unit to be synchronously turned on; and
during the connection or disconnection process, upon said control unit receiving the current transfer signal sent by said first sensing unit and the current transfer signal sent by said second sensing unit, said control unit synchronously outputting the second control signal to said first switch unit and to said second switch unit, causing said first switch unit and said second switch unit to be synchronously turned off.

5. The solid-state hybrid switchgear according to claim 1, wherein:
during the connection process, upon said control unit receiving at least one of the current transfer signal sent by said first sensing unit or the current transfer signal sent by said second sensing unit, said control unit bring further configured to start timing, and upon a first preset timing time period ending, output the second control signal to control at least one of said first switch unit or said second switch unit to be turned off, and within the first preset timing time period, the current being completely transferred at least one of from said first switch unit to said first arcing contact or from said second switch unit to said second arcing contact; or
during the disconnection process, upon said control unit receiving at least one of the current transfer signal sent by said first sensing unit or the current transfer signal sent by said second sensing unit, said control unit being further configured to start timing, and upon a second preset timing time period ending, output the second control signal to control at least one of said first switch unit or said second switch unit to be turned off, and within the second preset timing time period, the current being completely transferred at least one of from said first arcing contact to said first switch unit or from said second arcing contact to said second switch unit; and
the first preset timing time period being greater than the second preset timing time period.

6. The solid-state hybrid switchgear according to claim 1, wherein said first switch unit and said second switch unit are bidirectional semiconductor switch units or unidirectional semiconductor switch units.

7. The solid-state hybrid switchgear according to claim 6, which further comprises:
a DC positive terminal and a DC negative terminal;
upon said first isolating contact, said first arcing contact, said second isolating contact and said second arcing contact being provided between said DC positive terminal and said DC negative terminal, and said first switch unit and said second switch unit both being bidirectional semiconductor switch units, the solid-state hybrid switchgear being a bidirectional bipolar solid-state hybrid switchgear;
upon only said first isolating contact and said first arcing contact being provided between said DC positive terminal and said DC negative terminal, and said first switch unit being a bidirectional semiconductor switch unit, or only said second isolating contact and said second arcing contact being provided between said DC positive terminal and said DC negative terminal, and said second switch unit being a bidirectional semiconductor switch unit, the solid-state hybrid switchgear being a bidirectional unipolar solid-state hybrid switchgear;
upon said first isolating contact, said first arcing contact, said second isolating contact, and said second arcing contact being provided between said DC positive terminal and said DC negative terminal, and said first switch unit and said second switch unit both being unidirectional semiconductor switch units, the solid-state hybrid switchgear being a unidirectional bipolar solid-state hybrid switchgear; and
upon only said first isolating contact and said first arcing contact being provided between said DC positive terminal and said DC negative terminal, and said first switch unit being a unidirectional semiconductor switch unit, or only said second isolating contact and said second arcing contact being provided between said DC positive terminal and said DC negative terminal, and said second switch unit being a unidirectional semiconductor switch unit, the solid-state hybrid switchgear being a unidirectional unipolar solid-state hybrid switchgear.

8. The solid-state hybrid switchgear according to claim 2, which further comprises at least one of:
a first isolation unit connected to said first detection unit and configured to convert a high voltage input of the solid-state hybrid switchgear into a low voltage output, or
a second isolation unit being symmetrical with said first isolation unit, connected to said second detection unit and configured to convert a high voltage input of the solid-state hybrid switchgear into a low voltage output.

9. The solid-state hybrid switchgear according to claim 1, which further comprises at least one of:
a first protection unit connected in parallel with said first switch unit and configured to limit an input voltage of said first switch unit, or
a second protection unit being symmetrical with said first protection unit, connected in parallel with said second switch unit and configured to limit an input voltage of said second switch unit.

10. A control method for a solid-state hybrid switchgear, the control method comprising:
providing the solid-state hybrid switchgear, the solid-state hybrid switchgear including a first isolating contact, a first arcing contact, a second isolating contact, a second arcing contact, a first switch unit, a second switch unit and a control unit, the first isolating contact cooperating with the first arcing contact, the second isolating contact cooperating with the second arcing contact, the first switch unit being connected in parallel with the first arcing contact, the second switch unit being connected in parallel with the second arcing contact, and the control unit being separately connected to the first switch unit and to the second switch unit;
during a connection or disconnection process, outputting a first control signal to at least one of the first switch unit or the second switch unit to control at least one of the first switch unit or the second switch unit to be turned on, to transfer a contact current; and
upon a current transfer signal being received, outputting a second control signal to at least one of the first switch unit or the second switch unit to control at least one of the first switch unit or the second switch unit to be turned off, the current transfer signal including at least one of transfer of a current from the first switch unit to the first arcing contact during the connection process or transfer of a current from the second switch unit to the second arcing contact during the connection process, or at least one of transfer of a current from the first arcing contact to the first switch unit during the disconnection process or transfer of a current from the second arcing contact to the second switch unit during the disconnection process.

11. The control method for the solid-state hybrid switchgear according to claim 10, which further comprises:
during the connection process, upon the current transfer signal being received, starting timing, and upon a first preset timing time period ending, outputting the second control signal, and within the first preset timing time period, completely transferring the current at least one of from the first switch unit to the first arcing contact or from the second switch unit to the second arcing contact, or
during the disconnection process, upon the current transfer signal being received, starting timing, and upon a second preset timing time period ending, outputting the second control signal, and within the second preset timing time period, completely transferring the current at least one of from the first arcing contact to the first switch unit or from the second arcing contact to the second switch unit.
